(19) United States
(12) Patent Application Publication
(10) Pub. No.: US 2015/0163113 A1
(43) Pub. Date: Jun. 11, 2015

(54) COMMUNICATION CONTROL APPARATUS

(71) Applicant: Panasonic Intellectual Property Management Co., Ltd., Osaka (JP)

(72) Inventor: TATSUYA YOSHIDA, Kanagawa (JP)

(73) Assignee: Panasonic Intellectual Property Management Co., Ltd.

(21) Appl. No.: 14/535,710

(22) Filed: Nov. 7, 2014

(30) Foreign Application Priority Data
Dec. 11, 2013 (JP) 2013-256527

(51) Int. Cl. H04L 12/26

(52) U.S. Cl. CPC H04L 43/0829

(57) ABSTRACT

A communication control apparatus that monitors a network connection status of a device on a network, includes a detection unit configured to detect a communication state of the network, a setting unit configured to set a period in accordance with the communication state detected by the detection unit, a reception unit configured to receive data from the device via the network, and a controller configured to execute a predetermined process in the case where the reception unit fails to receive data from the device over the period.

### CROSS REFERENCE TO RELATED APPLICATION

The present application claims the benefit of Japanese Patent Application No. 2013-256527 filed on Dec. 11, 2013. The entire disclosure of the above-identified application, including the specification, drawings and claims, is incorporated herein by reference in its entirety.

### BACKGROUND

1. Technical Field

The present disclosure relates to communication control, and more particularly to a technique for detecting a network connection status of a device.

2. Description of the Related Art

As an alive monitoring technique for determining that a device connected to a network has entered a disconnected state, that is, the device has been disconnected, a method for repeatedly (periodically) transmitting a message (packet) to the device and checking whether or not there is a response from the device is widely used, for example. Japanese Unexamined Patent Application Publication No. 2004-364168 discloses a technique for detecting the communication state of a network and changing message transmission intervals on the basis of the detection result in the case where alive monitoring of a device is performed by periodically transmitting a message.

### SUMMARY

However, because the technique disclosed by Japanese Unexamined Patent Application Publication No. 2004-364168 merely changes message transmission intervals in accordance with the communication state of a network, the technique is not necessarily suitable for detecting disconnection of a device from the network.

One non-limiting and exemplary embodiment provides a communication control apparatus suitably capable of detecting disconnection of a device from a network.

Additional benefits and advantages of the disclosed embodiments will be apparent from the specification and figures. The benefits and/or advantages may be individually provided by the various embodiments and features of the specification and drawings disclosure, and need not all be provided in order to obtain one or more of the same.

In one general aspect, the techniques disclosed here feature: a communication control apparatus that monitors a network connection status of a device on a network, including a detection unit configured to detect a communication state of the network, a setting unit configured to set a period in accordance with the communication state detected by the detection unit, a reception unit configured to receive data from the device via the network, and a controller configured to execute a predetermined process in a case where the reception unit fails to receive data from the device over the period.

These general and specific aspects may be implemented as a system, a method, an integrated circuit, a computer program, or a computer-readable recording medium, or any combination of an apparatus, a system, a method, an integrated circuit, a computer program, and a computer-readable recording medium. Examples of the computer-readable recording medium include a nonvolatile recording medium, such as a Compact Disc-Read Only Memory (CD-ROM).

The communication control apparatus according to the one aspect of the present disclosure is suitably capable of detecting disconnection of a device from a network.

### BRIEF DESCRIPTION OF THE DRAWINGS

FIG. 1 is a schematic diagram illustrating a communication system according to an embodiment.

FIG. 2 is a block diagram illustrating functional configurations of a communication control apparatus and a device included in the communication system.

FIG. 3 is a diagram illustrating a set value table in accordance with a first embodiment.

FIG. 4 is a flowchart illustrating a connection check process.

FIG. 5 is a flowchart illustrating a disconnection detection process.

FIG. 6 is a diagram illustrating transmission of a connection check message and reception of connection confirmation data.

FIG. 7 is a flowchart illustrating a setting process.

FIG. 8 is a flowchart illustrating a no-reception-period threshold calculation process.

FIG. 9 is a diagram illustrating a logical connection relationship among a communication control apparatus and devices in a communication system according to a second embodiment.

FIG. 10 is a diagram illustrating a set value table in accordance with the second embodiment.

FIG. 11 is a block diagram illustrating a functional configuration of the communication control apparatus in accordance with one embodiment.

### DETAILED DESCRIPTION

A communication control apparatus according to one aspect of the present disclosure is a communication control apparatus that monitors a network connection status of a device on a network and includes a detection unit configured to detect a communication state of the network, a setting unit configured to set a period in accordance with the communication state detected by the detection unit, a reception unit configured to receive data from the device via the network, and a controller configured to execute a predetermined process in a case where the reception unit fails to receive data from the device over the period, in order to suitably detect disconnection of the device from the network. Here, the concept “detecting a communication state of the network” encompasses detecting the communication state by directly performing measurement and by receiving a result of measurement performed by another apparatus. The network whose communication state is to be detected includes at least part of a communication path between the device and the communication control apparatus. Also, examples of the predetermined process include a process for outputting information indicating that the device has been disconnected and a process for reconstructing a logical data distribution path between devices other than the disconnected device.

With the above configuration, a waiting time to receive data used for detecting disconnection of the device from the network can be adjusted in accordance with the communication state of the network. Thus, system requirements, such as one for ensuring that a false detection rate is suppressed to a predetermined value or lower even if the communication state changes, can be satisfied.

For example, the detection unit may detect, as the communication state of the network, a packet loss rate of the network. In a case where the packet loss rate detected by the detection unit is higher than a predetermined value, the setting unit may set a longer period than a period that is set in a case where the packet loss rate is equal to the predetermined value. In a case where the packet loss rate detected by the detection unit is lower than the predetermined value, the setting unit may set a shorter period than the period that is set in a case where the packet loss rate is equal to the predetermined value.

With this configuration, in the case where the packet loss rate of the network is low, that is, the communication state is good, the time taken to detect disconnection of the device from the network becomes shorter than that of the case where the packet loss rate is high. Consequently, an action can be quickly taken against the disconnection.

Also, for example, the communication control apparatus may further include an identifying unit configured to identify transmission intervals of connection confirmation data that is periodically transmitted from the device. The period may take a value which is represented as a relative magnitude based on the transmission intervals. In a case where the packet loss rate detected by the detection unit is higher than the predetermined value, the setting unit may set the period such that the value representing the period as a relative magnitude based on the transmission intervals is larger than the period that is set in a case where the packet loss rate is equal to the predetermined value. In a case where the packet loss rate detected by the detection unit is lower than the predetermined value, the setting unit may set the period such that the value representing the period as a relative magnitude based on the transmission intervals is smaller than the period that is set in a case where the packet loss rate is equal to the predetermined value.

With this configuration, in the case where the packet loss rate of the network is low, the time taken to detect disconnection relative to transmission intervals of a message or the like used for detecting disconnection of the device from the network becomes smaller than that of the case where the packet loss rate is high. Consequently, an action can be quickly taken against the disconnection when the transmission intervals are kept unchanged.

Also, the communication control apparatus may further include an identifying unit configured to identify transmission intervals of connection confirmation data that is periodically transmitted from the device, and a transmission-interval changing unit configured to perform control so as to reduce the transmission intervals of the connection confirmation data, in a case where the setting unit is unable to set the period such that a relationship is satisfied in which Ân, where n represents a ratio of the period to the transmission intervals and A represents the packet loss rate, is smaller than or equal to a predetermined upper-limit false detection rate which is the upper limit of a false detection rate regarding disconnection and the period is shorter than or equal to a predetermined upper-limit period which is the upper limit of the period. The setting unit may set the period such that the relationship is satisfied in which Ân is smaller than or equal to the predetermined upper-limit false detection rate and the period is shorter than or equal to the predetermined upper-limit period if possible.

With this configuration, the false detection rate can be suppressed to be within a range allowed by system requirements.

Also, the communication control apparatus may further include an input unit configured to accept input of information that represents the predetermined upper-limit false detection rate. The setting unit may set the period using the predetermined upper-limit false detection rate input via the input unit.

With this configuration, a system administrator or the like can specify or change the upper-limit false detection rate which is a system requirement.

Also, the communication control apparatus may further include an input unit configured to accept input of information that represents the predetermined upper-limit period. The setting unit may set the period using the predetermined upper-limit period input via the input unit.

With this configuration, a system administrator or the like can specify or change the upper-limit threshold of the time (no-reception period) taken to determine that the device has been disconnected as a result of unsuccessful reception of data from the device.

Also, the detection unit may detect the packet loss rate by calculating the packet loss rate on the basis of a frequency with which the reception unit has received data transmitted from the device.

With this configuration, a waiting time to receive data used for detecting disconnection of the device can be appropriately adjusted in accordance with the packet loss rate of the communication path used to receive the data from the device.

Also, the detection unit may repeatedly perform the detection, and the setting unit may determine a timing at which the period is updated, on the basis of a change in the communication state detected by the detection unit, and may set the period at the determined timing.

With this configuration, a timing at which the threshold is set can be adjusted in accordance with the communication state.

Also, the communication control apparatus may further include a transmission unit configured to transmit content data which represents at least one of video and audio to the device via the network. The device may have a function for transmitting the content data to an external terminal device upon receipt of the content data. The controller may execute, as the predetermined process, control for changing a transmission path on the network in order to transmit the content data to the external terminal device.

With this configuration, disconnection of the device can be suitably detected in accordance with the communication state of the network and a content data transmission path can be changed in response to the disconnection.

Also, the controller may execute, as the predetermined process, a process for outputting information indicating that the device has been disconnected from the network.

With this configuration, in the case where disconnection of the device from the network is detected, an indication regarding the disconnection is output.

Also, the detection unit may detect the communication state of the network by calculating a degree at which smooth transmission of data is disturbed over the network. In a case where the calculated degree is larger than a predetermined reference, the setting unit may set a longer period than a period set in a case where the calculated degree is smaller than the predetermined reference.

With this configuration, even in the case where the degree at which smooth transmission of data is disturbed over the network has changed, disconnection of the device from the network can be appropriately detected.

Also, the detection unit may calculate, as the degree, a probability that data expected to reach the communication control apparatus from the device is not successfully received after a certain period has passed from expected arrival time.

With this configuration, disconnection of the device from the network can be appropriately detected taking into consideration the data delay or the data loss of the network.

In addition, an integrated circuit according to one aspect of the present disclosure is an integrated circuit for monitoring a network connection status of a device on a network, including a reception unit configured to receive data from the device via the network, a detection unit configured to detect a communication state of the network, a setting unit configured to set a period in accordance with the communication state detected by the detection unit, and a controller configured to execute a predetermined process in a case where the reception unit fails to receive data from the device over the period.

In addition, a communication control method according to one aspect of the present disclosure is a communication control method employed by a communication control apparatus that monitors a network connection status of a device on a network, including a detecting step of detecting a communication state of the network, a setting step of setting a period in accordance with the communication state detected in the detecting step, a receiving step of receiving data from the device via the network, and a control step of executing a predetermined process in a case where data is not successfully received from the device over the period in the receiving step.

In addition, a non-transitory computer-readable recording medium according to one aspect of the present disclosure is a non-transitory computer-readable recording medium having a program causing an apparatus including a processor to execute a communication control process for monitoring a network connection status of a device on a network. The communication control process includes a detecting step of detecting a communication state of the network, a setting step of setting a period in accordance with the communication state detected in the detecting step, a receiving step of receiving data from the device via the network, and a control step of executing a predetermined process in a case where data is not successfully received from the device over the period in the receiving step.

Also in these aspects, a waiting time to receive data used for detecting disconnection of the device from the network can be adjusted in accordance with the communication state of the network. Thus, system requirements, such as one for ensuring that a false detection rate is suppressed to a predetermined value or lower even if the communication state changes, can be satisfied.

Note that these general and specific aspects may encompass any of or any combination of an apparatus, a system, a method, an integrated circuit, a computer program, and a computer-readable recording medium.

Embodiments will be described below with reference to the drawings.

Each of embodiments used herein describes a specific preferred example of the present disclosure. Accordingly, numerical values, shapes, materials, elements, arrangement and connection forms of the elements, steps (procedures), the order of the steps, and the like described in the following embodiments are merely examples, and do not limit the present disclosure. Also, among elements described in the following embodiments, elements that are not included in an independent claim which represents the highest concept of the present disclosure are elements that can be optionally added. Also, the drawings are schematic drawings and are not necessarily drawn strictly.

In each embodiment, a description will be given mainly of a communication control apparatus that adjusts the time taken to determine disconnection, in accordance with a communication state of a network and system requirements (such as detection accuracy and detection intervals) related to detection of disconnection of a device from a network. The communication control apparatus determines that the device has been disconnected from the network (detects disconnection) upon determining that a period over which connection confirmation data expected to be periodically transmitted from the device is no successfully received has exceeded a threshold (no-reception-period threshold). Here, the period over which connection confirmation data is not successfully received indicates a period over which the communication control apparatus fails to receive the connection confirmation data despite an attempt to receive the connection confirmation data.

### First Embodiment

A first embodiment which is one embodiment of the present disclosure will be described below.

### Configuration

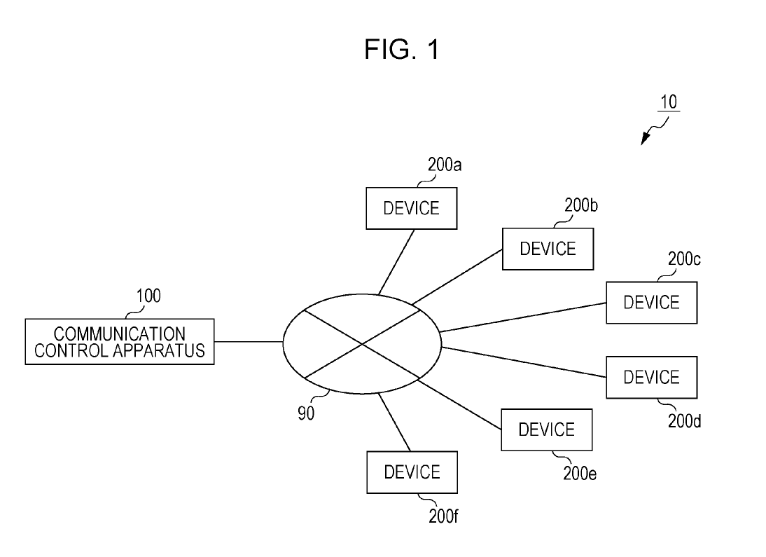

FIG. 1 is a schematic diagram illustrating a communication system 10 according to the first embodiment.

The communication system 10 is a system that enables communication between a plurality of devices 200a to 200f via a network 90 for communication, such as the Internet. A communication control apparatus 100 that controls communication between the devices 200a to 200f monitors network connection statuses of the devices 200a to 200f (performs so-called alive monitoring), and executes a disconnection handling process upon detecting disconnection of each of the devices 200a to 200f from the network 90. The disconnection handling process is a process for taking an action against disconnection. The disconnection handling process may be, for example, displaying that disconnection has occurred or information regarding the disconnected device on a display device. Alternatively, the disconnection handling process may be transmitting information regarding the disconnected device to other devices.

FIG. 1 illustrates six devices 200a to 200f that perform communication with one another, as exemplary devices whose network connection statues are monitored (devices subjected to alive monitoring performed) by the communication control apparatus 100. As illustrated in FIG. 1, the communication system 10 includes the network 90, the communication control apparatus 100, and the devices 200a to 200f. Here, the network 90 may be any type of network, such as a mobile communication network or a local communication network (such as a local area network (LAN)), in addition to the Internet. Also, it does not matter whether network paths in the network 90 are wired or wireless.

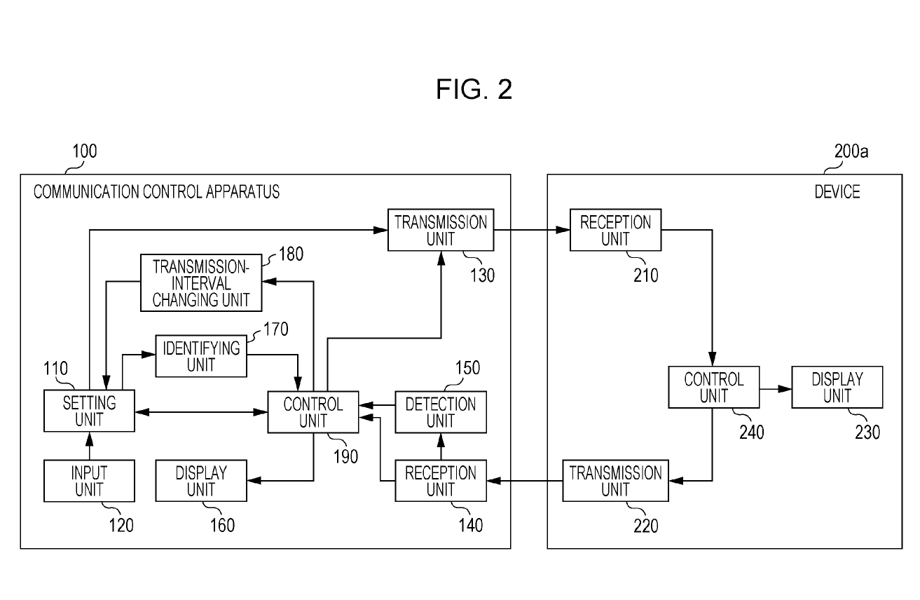

FIG. 2 is a block diagram illustrating functional configurations of the communication control apparatus 100 and the device 200a included in the communication system 10. FIG. 2 illustrates only the communication control apparatus 100 and the device 200a, and omits illustration of the other devices 200b to 200f.

Here, the communication control apparatus 100 is constituted by a computer which includes a memory, a processor, a timing mechanism (timer), and a communication circuit. In terms of functionality, the communication control apparatus 100 includes a setting unit 110, an input unit 120, a transmission unit 130, a reception unit 140, a detection unit 150, a display unit 160, an identifying unit 170, a transmission-interval changing unit 180, and a control unit 190 as illustrated in FIG. 2. In order to perform alive monitoring of the devices 200a to 200f, the communication control apparatus 100 executes a connection check process, a disconnection detection process, and a setting process which are described later.

The setting unit 110 has a function for setting and storing various pieces of data in a storage medium, such as a memory or a hard disk. Note that setting of various pieces of data performed by the setting unit 110 includes newly setting and resetting, that is, updating. The pieces of data stored by the setting unit 110 include, for example, data that represents transmission intervals at which the transmission unit 130 transmits a connection check message and a no-reception-period threshold which is a threshold for a period over which data is not successfully received from the device 200a and is used to determine disconnection.

The input unit 120 includes an input device, such as a keyboard or a touchscreen, and has a function for causing the setting unit 110 to store a set value input by a user.

The transmission unit 130 includes part of the communication circuit, and has a function for transmitting data (packet) to the device 200a or the like. Data transmitted using this function includes a connection check message which is a message for requesting the device 200a or the like to return a response. The connection check message is used to check a network connection status of the device 200a or the like.

The reception unit 140 includes part of the communication circuit, and has a function for receiving data (packet) from the network 90. The data received from the network 90 includes connection confirmation data which is transmitted from the device 200a or the like as a response to the connection check message.

The detection unit 150 has a function for detecting a communication state of the network 90, on the basis of the data received by the reception unit 140. For example, the detection unit 150 detects the communication state of the network 90 by using a loss rate which represents a ratio of the number of packets that have been lost on the network 90 and have not reached the communication control apparatus 100 to an amount of data (the number of packets) expected to reach the communication control apparatus 100. Note that if a packet of the connection check message or the connection confirmation data is lost on the network 90, the communication control apparatus 100 may falsely detect that the device that is actually connected to the network 90 is disconnected.

The display unit 160 includes a display device (e.g., a liquid crystal display), and has a function for displaying information to a user.

The identifying unit 170 has a function for identifying transmission intervals at which connection confirmation data is transmitted from each device, such as the device 200a, on the basis of the data stored by the setting unit 110.

The transmission-interval changing unit 180 has a function for updating, in response to a request of the control unit 190, data that represents the transmission intervals and that is stored by the setting unit 110.

The control unit 190 has functions for determining that the device 200a or the like has been disconnected from the network 90 in the case where a period over which the reception unit 140 fails to receive data from the device has exceeded the no-reception-period threshold and for executing the disconnection handling process (such as displaying an indication of the disconnection on the display unit 160). The control unit 190 also has functions, such as a function for controlling transmission of a connection check message performed by the transmission unit 130, a function for requesting the transmission-interval changing unit 180 to update the transmission intervals under a certain condition, and a function for calculating the no-reception-period threshold and causing the setting unit 110 to set the calculated no-reception-period threshold.

Some or all of the functions of the setting unit 110, the detection unit 150, the identifying unit 170, the transmission-interval changing unit 180, and the control unit 190 are implemented as a result of a processor executing a control program stored in a memory included in the communication control apparatus 100.

The device 200a is constituted by a computer which includes a memory, a processor, and a communication circuit. In terms of functionality, the device 200a includes a reception unit 210, a transmission unit 220, a display unit 230, and a control unit 240 as illustrated in FIG. 2.

The reception unit 210 includes part of the communication circuit, and has a function for receiving data (packet) from the network 90. Examples of data received from the network 90 include data transmitted from the other devices 200b to 200f and a connection check message transmitted from the communication control apparatus 100.

The transmission unit 220 includes part of the communication circuit, and has a function for transmitting data (packet) to the other devices 200b to 200f and the communication control apparatus 100. Examples of data transmitted using this function include response data (connection confirmation data) of the connection check message transmitted from the communication control apparatus 100.

The display unit 230 includes a display device, and has a function for displaying information to a user of the device 200a.

The control unit 240 has functions for causing the display unit 230 to display information in accordance with data received by the reception unit 210, and for controlling transmission performed by the transmission unit 220. These functions are implemented as a result of a processor executing a control program stored in a memory included in the device 200a. This control program includes a program which causes the transmission unit 220 to execute a process for transmitting connection confirmation data upon receipt of a connection check message from the communication control apparatus 100.

Although not illustrated in FIG. 2, the devices 200b to 200f have substantially the same functional configuration as the device 200a.

### Data Structure

The following describes data used in alive monitoring performed by the communication control apparatus 100 in the communication system 10 having the above-described configuration.

In addition to the data representing the transmission intervals of the connection check message and the no-reception-period threshold which is a threshold used to determine disconnection, the setting unit 110 of the communication control apparatus 100 stores data representing system requirements (detection accuracy and detection intervals) related to detection of disconnection of the device from the network 90. Specifically, one piece of data concerning the system requirements is an upper-limit false detection rate. The upper-limit false detection rate is the upper limit of a rate (false detection rate) of false detection of disconnection of the device from the network 90 allowed by the system, and takes a value larger than or equal to 0 and smaller than or equal to 1. That is, the upper-limit false detection rate is an upper limit value up to which it is allowed to falsely detect disconnection of the device from the network 90 although the device has not been disconnected from the network 90, and is a value of 10⁻²⁴, for example. Another piece of data concerning the system requirements is an upper-limit no-reception-period threshold which is the upper-limit value of the no-reception-period threshold allowed by the system. The no-reception-period threshold is a threshold used in disconnection determination. The upper-limit no-reception-period threshold is 3600 milliseconds, for example. The upper-limit false detection rate and the upper-limit no-reception-period threshold are specified, for example, by a user such as a system administrator via the input unit 120, and are set and stored by the setting unit 110. These pieces of data concerning the system requirements are used in the setting process (described later) for setting the no-reception-period threshold or the like.

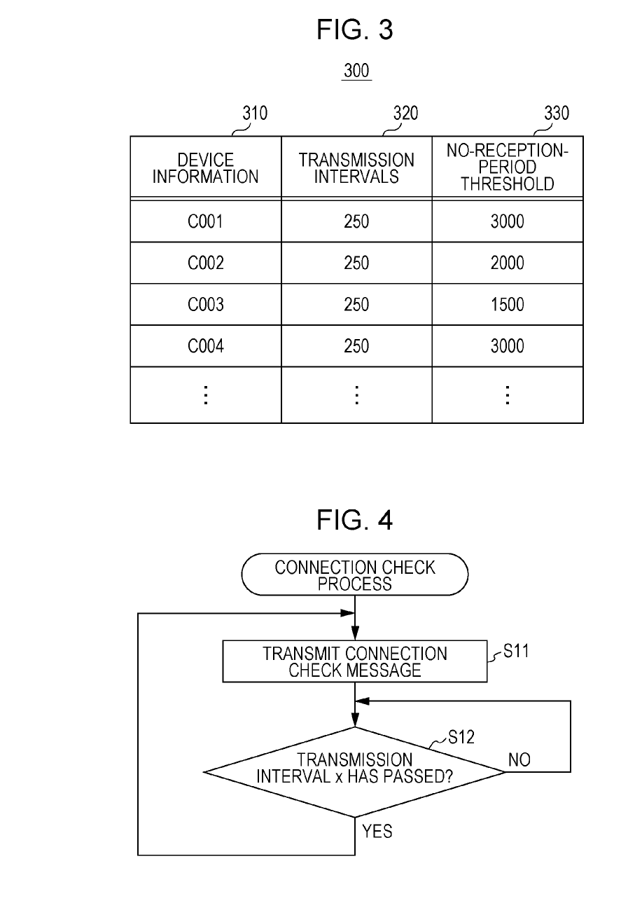

The setting unit 110 further stores a set value table 300. FIG. 3 is a diagram illustrating a structure and exemplary contents of the set value table 300.

The set value table 300 is information in which, for each device subjected to alive monitoring, values used for determining whether or not the device has been disconnected from the network 90 are set.

As illustrated in FIG. 3, the set value table 300 includes, for each device subjected to alive monitoring, device information 310, transmission intervals 320, and a no-reception-period threshold 330. Here, the device information 310 for a given device includes various pieces of information such as a device ID and an Internet Protocol address (IP address) of the device (illustration of information other than the device ID is omitted in FIG. 3). The transmission intervals 320 are information indicating cycles at which the communication control apparatus 100 periodically transmits a connection check message to the device. The no-reception-period threshold 330 for a given device is information indicating a waiting time to receive data from the device in order to determine disconnection of the device from the network 90.

The exemplary contents of FIG. 3 will be described by assuming that the device 200a has a device ID “C001”.

According to the exemplary contents of FIG. 3, transmission cycles (transmission intervals) of the connection check message and the no-reception-period threshold set for the device 200a indicated by the device information 310 including the device ID “C001” is 250 milliseconds and 3000 milliseconds (three seconds), respectively. Therefore, if data from this device 200a is not successfully received over three seconds, it is determined that the device 200a has been disconnected from the network 90. Note that the transmission intervals 320 and the no-reception-period threshold 330 set for each device can be changed through the setting process (described later).

Further, the setting unit 110 pre-stores a transmission-interval base value (e.g., 250 milliseconds), which is the initial value (default value) of the transmission intervals 320 for all devices. The setting unit 110 also sets the initial value of the transmission intervals 320 in the set value table 300 to be equal to this transmission-interval base value. Note that this transmission-interval base value may be specified by a user such as a system administrator via the input unit 120.

### Operations

The following describes operations performed by the communication control apparatus 100 and the devices 200a to 200f included in the communication system 10 that has the above-described configuration and handles the above-described pieces of data.

FIG. 4 is a flowchart illustrating the connection check process. This connection check process is performed by the communication control apparatus 100 to periodically transmit a connection check message to each device subjected to alive monitoring. Now, the connection check process executed on the device 200a will be described.

The control unit 190 of the communication control apparatus 100 controls the transmission unit 130 to cause the transmission unit 130 to transmit a connection check message to the device 200a (step S11). The connection check message is data in a predetermined format for data requesting each of the devices 200a to 200f to transmit a response, and is, for example, a message according to Internet Control Message Protocol (ICMP) or the like. Note that the control unit 190 refers to the set value table 300 stored by the setting unit 110, and informs the transmission unit 130 of the transmission intervals 320 which indicate transmission cycles at which the connection check message is transmitted to the device 200a. In this way, the transmission unit 130 transmits the connection check message (step S11) every time a period indicated by the transmission intervals 320 (250 milliseconds in the example of FIG. 3) passes (step S12). Now, it is assumed that the device ID of the device 200b is “C002”. According to the example of FIG. 3, the transmission unit 130 transmits a connection check message to the device 200b at intervals of 250 milliseconds (steps S11 and S12) in parallel with the process performed on the device 200a. In this way, the transmission unit 130 repeatedly transmits the connection check messages to the devices 200a to 200f in parallel.

It is expected that the connection check message transmitted to the device 200a in step S11 reaches the device 200a via the network 90. Upon the reception unit 210 of the device 200a receiving the connection check message, the transmission unit 220 transmits connection confirmation data to the communication control apparatus 100 under control of the control unit 240. The connection confirmation data is also data in a predetermined format, and is a message according to ICMP or the like, for example. Depending on the communication state of the network 90, the transmitted connection check message may be discarded by a router or the like on the network 90 before it reaches the device 200a and may be lost. Similarly, the connection confirmation data which is a response from the device 200a may also be lost.

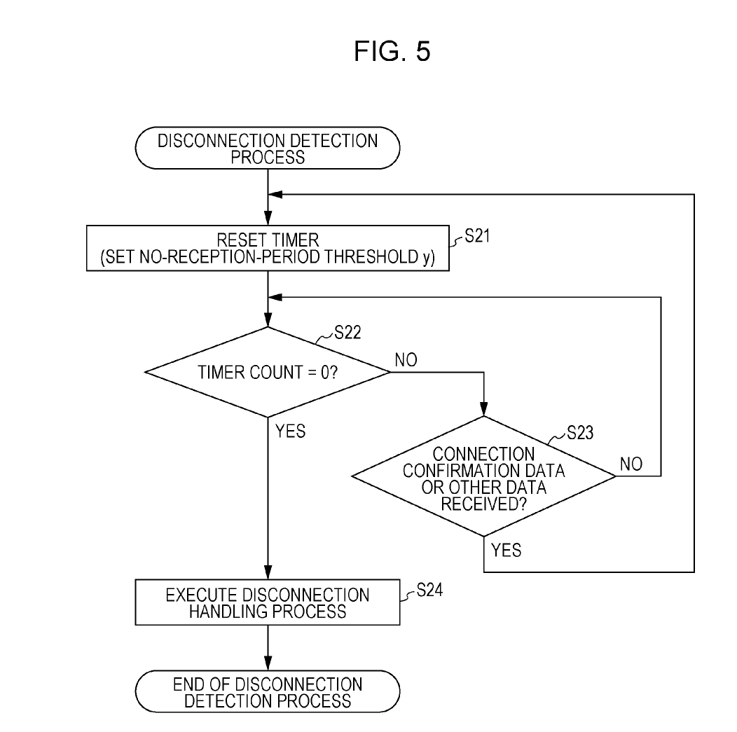

FIG. 5 is a flowchart illustrating the disconnection detection process. This disconnection detection process is executed by the communication control apparatus 100 on each device subjected to alive monitoring in order to determine whether or not the device has been disconnected from the network 90, that is, detect disconnection. Here, the disconnection detection process for detecting disconnection of the device 200a will be described.

The control unit 190 of the communication control apparatus 100 sets a timer for a period over which it is not determined that the device 200a is disconnected even if data is not received from the device 200a, that is, the no-reception-period threshold stored by the setting unit 110 as the contents of the set value table 300 (step S21). Note that the setting process for setting the no-reception-period threshold in the set value table 300 will be described later.

The timer which has been set for the no-reception-period threshold in step S21 counts down. When the value of the timer becomes zero (step S22), the control unit 190 executes a disconnection handling process (step S24). The control unit 190 waits to receive some kind of data including the connection confirmation data from the device 200a until the value of the timer becomes zero (step S23). If the data is successfully received, the control unit 190 resets the timer. That is, the process returns to the processing (step S21) in which the timer is set for the no-reception-period threshold.

Through such a disconnection detection process, it is determined that the device 200a has been disconnected from the network 90 only in the case where the connection confirmation data transmitted from the device 200a in response to the connection check message transmitted from the communication control apparatus 100 or some kind of data transmitted from the device 200a to the communication control apparatus 100 has not been received for a period that exceeds the no-reception-period threshold. The case where data has not been received for a period that exceeds the no-reception-period threshold is, in order words, the case where a period over which data is not successfully received despite an attempt to receive the data has exceeded the no-reception-period threshold. Note that the control unit 190 detects disconnection of the individual devices 200a to 200f from the network 90 in parallel to one another.

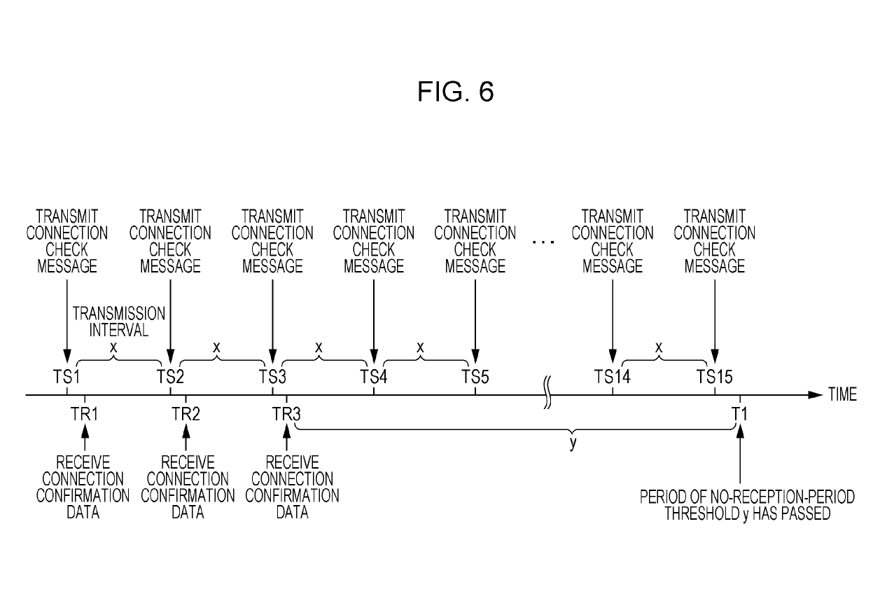

Timings of data transmission and reception that are executed through the connection check process and the disconnection detection process described based on FIGS. 4 and 5 will be described below using FIG. 6.

FIG. 6 is a diagram illustrating timings at which the connection check message is transmitted to and the connection confirmation data is received from the device 200a by the communication control apparatus 100, respectively.

As illustrated in FIG. 6, the connection check message that requests a response is transmitted from the communication control apparatus 100 to the device 200a at times TS1, TS2, TS3, TS4, TS5, . . . , TS14, and TS15. Intervals such as an interval between times TS2 and TS1 and an interval between times TS3 and TS2 are equal to a period x (250 milliseconds in the example of FIG. 3) indicated by the transmission intervals 320 set for the device 200a in the set value table 300.

The connection confirmation data which is response data transmitted from the device 200a at time TS1 is received by the communication control apparatus 100 at time TR1, which is immediately after time TS1. Also, the connection confirmation data from the device 200a which is a response to the connection check message transmitted from the communication control apparatus 100 at time TS2 is received at time TR2. Similarly, the connection confirmation data from the device 200a which is a response to the connection check message transmitted at time TS3 is received at time TR3. In the example illustrated in FIG. 6, response data (connection confirmation data) of the connection check messages periodically transmitted from the communication control apparatus 100 at and after time TS4 is not received by the communication control apparatus 100 because it has been lost over the network 90 or the like. If the communication control apparatus 100 fails to receive data from the device 200a after a period y (three seconds in the example of FIG. 3) indicated by the no-reception-period threshold 330 of the set value table 300 has passed from the last reception of data from the device 200a, the communication control apparatus 100 determines that the device 200a has been disconnected from the network 90.

The setting process executed by the communication control apparatus 100 will be described below.

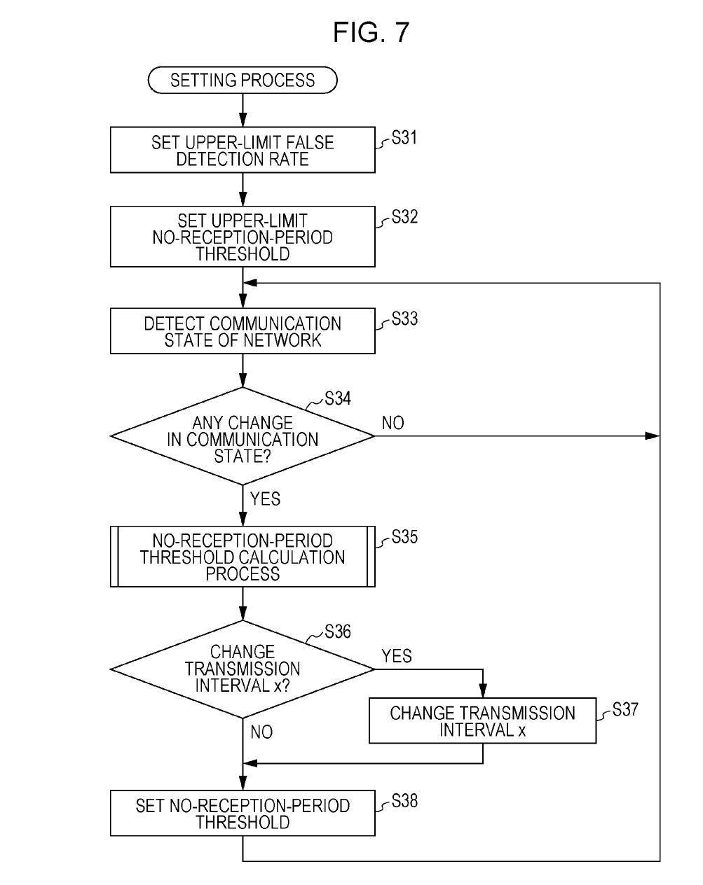

FIG. 7 is a flowchart illustrating the setting process.

When the system operation is started (when execution of the device alive monitoring function is started), the setting unit 110 of the communication control apparatus 100 stores the upper-limit false detection rate upon the upper-limit false detection rate being specified by a user via the input unit 120 (step S31). Also, the setting unit 110 stores the upper-limit no-reception-period threshold upon the upper-limit no-reception-period threshold being specified by a user via the input unit 120 (step S32). Each of the upper-limit false detection rate and the upper-limit no-reception-period threshold is not set differently for different devices subjected to alive monitoring but is set to be the same for all the devices subjected to alive monitoring.

Then, the communication control apparatus 100 executes, for each of the devices subjected to alive monitoring, processing of steps S33 to S38 described below. That is, the communication control apparatus 100 sets the no-reception-period threshold for each of the devices.

The detection unit 150 of the communication control apparatus 100 detects the communication state (e.g., a loss rate) of the network 90 (step S33). Specifically, in order to set the no-reception-period threshold for the device 200a, the detection unit 150 detects a degree of packet loss (loss rate) on a data communication path between the communication control apparatus 100 and the device 200a. This loss rate is calculated based on a frequency with which the reception unit 140 has received data transmitted from the device 200a. In other words, the loss rate is determined by calculating a ratio of the number of packets not received by the communication control apparatus 100 after a sufficiently long period (for example, one minute from when the device 200a transmitted the data) to the number of packets planned to be transmitted from the device 200a during a predetermined past period (for example, a period from five minutes ago to one minute ago from now). Note that any other method may be used as the method for calculating the degree of packet loss (loss rate).

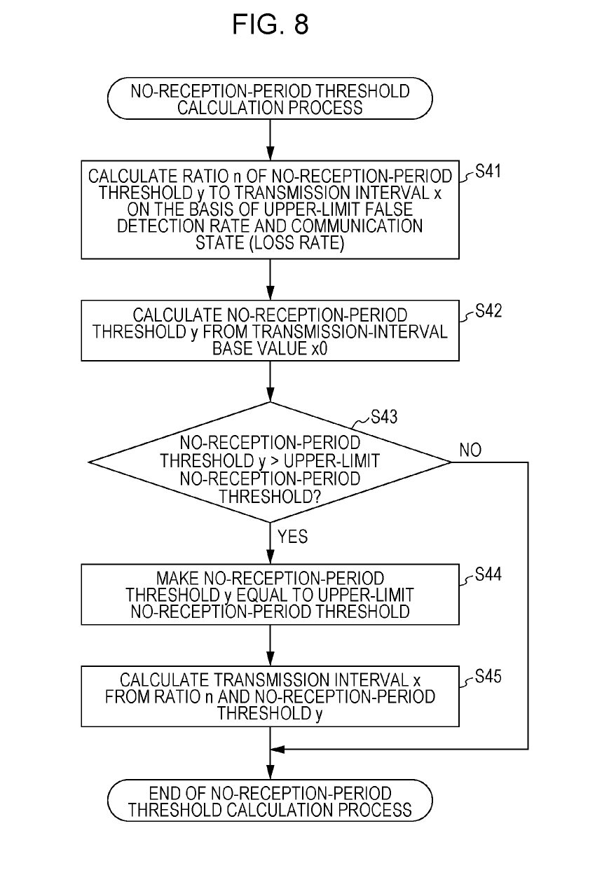

The control unit 190 is informed of the detection result by the detection unit 150, and compares the informed detection result with the last detection result. If the communication state (e.g., the loss rate) has changed (YES in step S34), the control unit 190 executes a no-reception-period threshold calculation process for calculating the no-reception-period threshold (step S35). Contents of this no-reception-period threshold calculation process performed for the device 200a in step S35 will be described using FIG. 8.

FIG. 8 is a flowchart illustrating the no-reception-period threshold calculation process.

Based on the upper-limit false detection rate stored by the setting unit 110 and the communication state (e.g., the loss rate) informed by the detection unit 150, the control unit 190 calculates a ratio n of a period y which is the no-reception-period threshold (hereinafter, referred to as the no-reception-period threshold y) to a period x which is the transmission intervals (hereinafter, referred to as the transmission intervals x) (step S41). Note that the ratio n is larger than 1. In the case where the communication state is represented by the loss rate, a relationship among a false detection rate P, a loss rate A, and the ratio n is expressed by Equation 1 below. Note that it is assumed that the loss rate A and the false detection rate P take values larger than or equal to 0 and smaller than or equal to 1.

P=Ân (Expression 1)

Accordingly, the ratio n that makes the false detection rate P lower than or equal to the upper-limit false detection rate can be calculated. According to Equation 1, when the ratio n is larger than 1, in the case where the loss rate A is higher than a predetermined value, the ratio n that makes the false detection rate P equal to the upper-limit false detection rate becomes larger than that of the case where the loss rate A is equal to the predetermined value. In the case where the loss rate A is lower than the predetermined value, the ratio n that makes the false detection rate P equal to the upper-limit false detection rate becomes smaller than that of the case where the loss rate A is equal to the predetermined value. Although Equation 1 expresses the relationship between the false detection rate P and the ratio n by using the loss rate A, the ratio n may be calculated from the upper-limit false detection rate on the basis of a relational expression that expresses the relationship between the false detection rate P and the ratio n by using an index other than the loss rate A. That is, an index A′ which represents a degree at which smooth transmission of data is disturbed over the network 90 is measured using data that has been successfully received via the network 90, and a relational expression (Expression 2 below) which expresses the relationship between the false detection rate P and the ratio n by using the index A′ may be formed through actual measurement and may be utilized. Expression 2 is a relational expression which indicates that the false detection rate P is determined by a function f that uses the index A′ and the ratio n. According to the relational expression (Expression 2) thus formed, in the case where the index A′ is larger than a predetermined reference (value), the ratio n that makes the false detection rate P equal to the upper-limit false detection rate becomes larger than that of the case where the index A′ is smaller than the predetermined reference (value).

P=f(A′,n) (Expression 2)

This index A′ that represents the degree at which smooth transmission of data is disturbed may be measured (calculated) as a probability of unsuccessful reception of data that is expected to reach the communication control apparatus 100 from the device 200a even after a certain period has passed from the expected arrival time. Alternatively, an amount of data delay (for example, an average of amounts of data delay measured over a certain period near the present) may be used as the index A′. The amount of data delay may be determined by measuring the round trip time (RTT), for example.

Subsequently to calculation of the ratio n in step S41, the control unit 190 calculates the no-reception-period threshold y from the calculated ratio n and a period x0 indicated by the transmission-interval base value (hereinafter, referred to as the transmission-interval base value x0) stored by the setting unit 110 (step S42). The no-reception-period threshold y is calculated as a product of the transmission-interval base value x0 by the ratio n. Thus, in the case where the ratio n is larger than 1, the no-reception-period threshold y becomes smaller as the loss rate A becomes lower according to Expression 1. This indicates that when the communication state is good, such as when the loss rate is relatively low, the time taken to determine that the device has been disconnected from the network 90 consequently reduces.

The control unit 190 determines whether or not the calculated no-reception-period threshold y exceeds the upper-limit no-reception-period threshold (step S43). If the no-reception-period threshold y does not exceed the upper-limit no-reception-period threshold, the control unit 190 ends the no-reception-period threshold calculation process. In this case, because the transmission intervals x need not be changed (step S36 in FIG. 7), the control unit 190 causes the setting unit 110 to set the calculated no-reception-period threshold y in the set value table 300 (step S38). Specifically, the setting unit 110 sets the no-reception-period threshold y such that a relationship is satisfied in which Ân, where A represents the loss rate and n represents a ratio of the no-reception-period threshold y to the transmission intervals x, is smaller than or equal to the upper-limit false detection rate and the no-reception-period threshold y is smaller than or equal to the upper-limit no-reception-period threshold if possible.

If it is determined in step S43 that the calculated no-reception-period threshold y exceeds the upper-limit no-reception-period threshold, the control unit 190 sets the upper-limit no-reception-period threshold as the no-reception-period threshold y (step S44). Subsequently, the control unit 190 calculates the transmission intervals x by dividing the no-reception-period threshold y by the ratio n (step S45), and ends the no-reception-period threshold calculation process. In this case, the transmission intervals x need to be changed (step S36 in FIG. 7), the control unit 190 causes the setting unit 110 to set the calculated transmission intervals x in the set value table 300 (step S37). Then, the control unit 190 causes the setting unit 110 to set the no-reception-period threshold y, which is equal to the upper-limit no-reception-period threshold, in the set value table 300 (step S38). When the no-reception-period threshold y is set to a large value, it takes long to detect disconnection of the device from the network 90 from when the device was actually disconnected from the network 90, and the real-time performance of the system decreases. For this reason, a certain upper-limit no-reception-period threshold is set as a system requirement. In addition, when the transmission intervals x are reduced, the number of messages or the like for alive monitoring transmitted over the network 90 increases, and this increase may worsen the communication state. For this reason, the transmission intervals x are kept unchanged as long as the no-reception-period threshold y is smaller than or equal to the upper-limit no-reception-period threshold which is a system requirement.

Note that the control unit 190 repeatedly executes the processing of step S33 and subsequent steps. Also, in step S34, if there is no change in the detected communication state (e.g., the loss rate), the process returns to step S33 in which the control unit 190 detects the communication state of the network again.

As described above, through the setting process (see FIG. 7) which includes the no-reception-period threshold calculation process (see FIG. 8), the no-reception-period threshold y is set (reset) in accordance with the communication state (e.g., the loss rate) of the network 90 that can change over time, and the transmission intervals x are set (reset) if necessary. As a result, a waiting time to receive data up to execution of the disconnection handling process of the disconnection detection process (see FIG. 5) is changed in accordance with the communication state of the network 90. In the case where the communication state of the network 90 is good, the average time from when the device is actually disconnected from the network 90 to when the disconnection handling process is executed can be made shorter than that of the case where the communication state of the network 90 is not good. The state in which the communication state of the network 90 is good is a state in which the degree at which smooth transmission of data is disturbed over the network 90 is relatively small and a state in which the loss rate is relatively low, for example. In the case where the transmission intervals x stored by the setting unit 110 are reset through the setting process (see FIG. 7), intervals at which the connection check message is transmitted through the connection check process (see FIG. 4) are changed to be the reset value.

By executing the above-described setting process (see FIG. 7) for each device in this manner, the communication control apparatus 100 sets (resets) the no-reception-period threshold 330 or the like in the set value table 300.

A specific example of how the no-reception-period threshold 330 is set will be described below by using the exemplary contents of FIG. 3 again.

It is assumed here that the transmission-interval base value x0 is 250 milliseconds, the upper-limit false detection rate is 1.0*10̂−24(10⁻²⁴), and the upper-limit no-reception-period threshold is 3600 milliseconds. Also, a timing is assumed at which the loss rate of a network path between the communication control apparatus 100 and the device 200a is 0.01, the loss rate of a network path between the communication control apparatus 100 and the device 200b is 0.001, and the loss rate of a network path between the communication control apparatus 100 and the device 200c is 0.0001.

Regarding the device 200a having the device ID “C001”, the ratio n is determined to be 12 from the upper-limit false detection rate, Expression 1, and the loss rate; and the no-reception-period threshold y is determined to be 3000 milliseconds from this ratio n and the transmission-interval base value x0. Since the determined no-reception-period threshold y that is 3000 milliseconds does not exceed the upper-limit no-reception-period threshold, the transmission intervals x are determined to be 250 milliseconds. Regarding the device 200b having the device ID “C002”, the ratio n is determined to be 8 from the upper-limit false detection rate, Expression 1, and the loss rate; and the no-reception-period threshold y is determined to be 2000 milliseconds from this ratio n and the transmission-interval base value x0. Similarly, regarding the device 200c having the device ID “C003”, the ratio n is determined to be 6 from the upper-limit false detection rate, Expression 1, and the loss rate; and the no-reception-period threshold y is determined to be 1500 milliseconds from this ratio n and the transmission-interval base value x0. The set value table 300 in which the no-reception-period threshold thus determined and so on are set has the exemplary contents of FIG. 3. Accordingly, a relatively small value can be set as the no-reception-period threshold y for a device that transmits connection confirmation data on a network path having a relatively low loss rate, and determination as to whether the device has been disconnected can be performed relatively quickly.

### Second Embodiment

A second embodiment which is one embodiment of the present disclosure will be described below.

The communication system 10 (see FIG. 1) according to the second embodiment is a system that is operated such that the communication control apparatus 100 distributes content data including video to the devices 200a to 200f via the network 90. Note that the communication control apparatus 100 and the devices 200a to 200f included in the communication system 10 are substantially the same as those of the first embodiment in terms of hardware and functionality related to alive monitoring (see FIG. 2). The communication control apparatus 100 and the devices 200a to 200f have a content data transmission/reception function that is not directly related to alive monitoring, which is different from the first embodiment. Also, in the second embodiment, the communication control apparatus 100 individually sets the upper-limit no-reception-period threshold for each of the devices 200a to 200f.

In the second embodiment, the network 90 is treated logically as a tree-structure path in which the communication control apparatus 100 serves as the root in order to distribute content data.

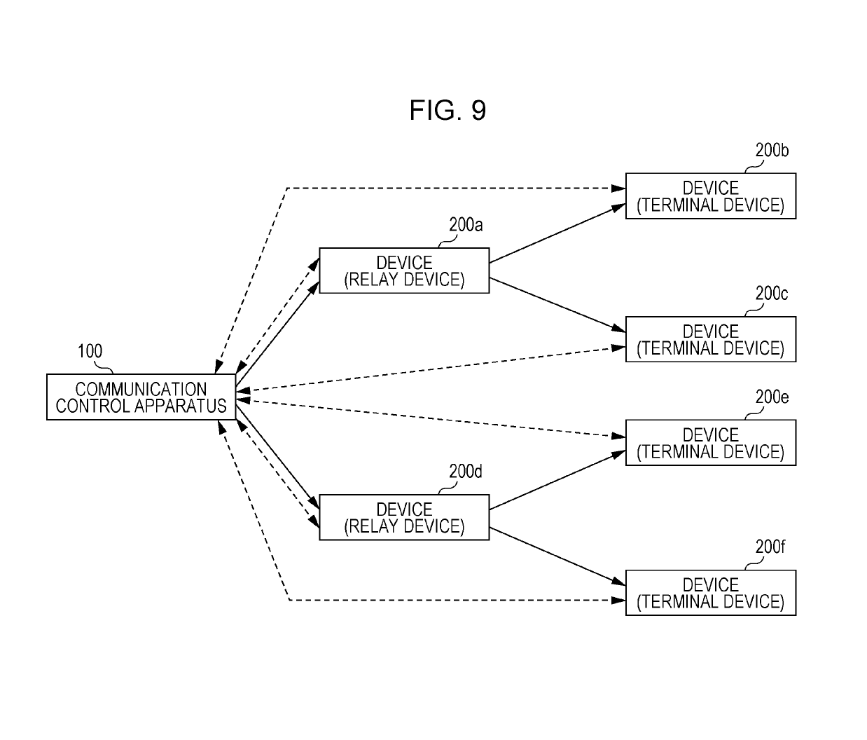

FIG. 9 is a diagram illustrating a logical connection relationship among the communication control apparatus 100 and the devices 200a to 200f. In FIG. 9, a solid-line arrow represents the flow of content data distribution, and a dashed-line arrow represents the flow of communication for alive monitoring (transmission/reception of the connection check message and the connection confirmation data).

As illustrated in FIG. 9, the communication control apparatus 100 distributes content data to the devices 200a and 200d. Also, the device 200a transfers the received content data to the devices 200b and 200c, whereas the device 200d transfers the received content data to the devices 200e and 200f. Also, each of the devices 200a to 200f that have received the content data displays video included in the received content data.

In order to implement the logical connection relationship among the communication control apparatus 100 and the devices 200a to 200f illustrated in FIG. 9, the communication control apparatus 100 has a function for determining and managing which node in the distribution tree structure corresponds to which device, and for transmitting data representing the entirety or part of the distribution tree structure to each device. The devices 200a and 200d are nodes that function as relay devices during distribution. The devices 200b, 200c, 200e, and 200f are nodes that function as terminal devices which do not distribute the content data to other devices.

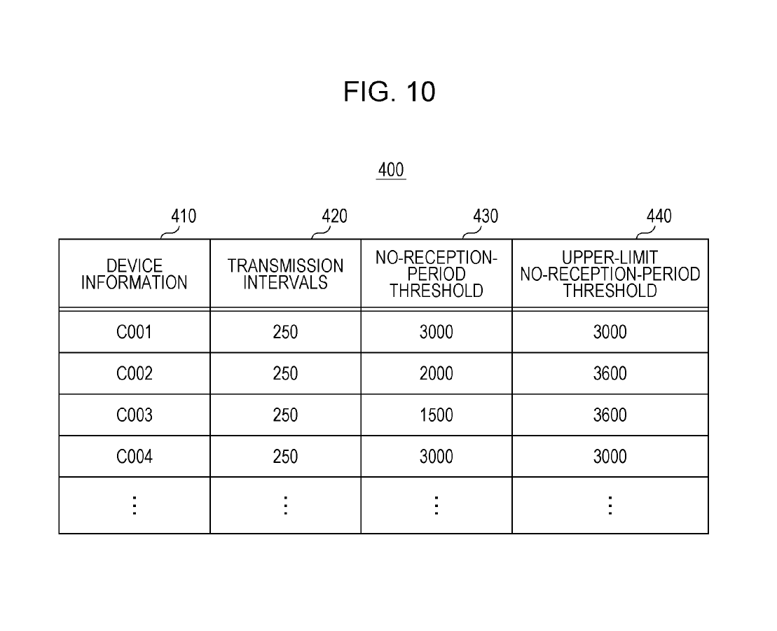

FIG. 10 is a diagram illustrating a structure and exemplary contents of a set value table 400 stored by the setting unit 110 of the communication control apparatus 100 in the second embodiment.

As illustrated in FIG. 10, the set value table 400 is information in which, for each device subjected to alive monitoring, values used for determining whether or not the device has been disconnected from the network 90 is set.

As illustrated in FIG. 10, the set value table 400 includes, for each device subjected to alive monitoring, device information 410, transmission intervals 420, a no-reception-period threshold 430, and an upper-limit no-reception-period threshold 440. Here, the device information 410, the transmission intervals 420, and the no-reception-period threshold 430 for a given device are the same as the device information 310, the transmission intervals 320, and the no-reception-period threshold 330 described in the first embodiment, respectively. The upper-limit no-reception-period threshold 440 is an upper-limit value of the no-reception-period threshold allowed by the system for each device. The communication control apparatus 100 according to the second embodiment sets different no-reception-period thresholds for individual devices, depending on whether the device functions as the relay device or the terminal device. According to the exemplary contents of FIG. 10, the upper-limit no-reception-period threshold is set to 3000 milliseconds for a device that functions as a relay device and 3600 milliseconds for a device that functions as a terminal device. System requirements are set taking into consideration the fact that the relay device has a more important role (role for transferring content data) than the terminal apparatus in order to implement the flow of content data distribution illustrated in FIG. 9. That is, the exemplary contents of FIG. 10 indicate an example in which the upper-limit no-reception-period threshold which is a system requirement is defined on the basis of the fact that in the case where the relay device is disconnected from the network, the disconnection needs to be detected more quickly than disconnection of the terminal device.

The communication control apparatus 100 according to the second embodiment also executes the connection check process (see FIG. 4), the disconnection detection process (see FIG. 5), and the setting process (see FIGS. 7 and 8) described in the first embodiment.

Upon detecting disconnection of the device 200a that functions as a relay device from the network 90, the communication control apparatus 100 executes, as the disconnection handling process, a process related to control for causing the device 200b to function as a relay device by changing the distribution tree structure. That is, the disconnection handling process of this case is control for changing a transmission path of the content data on the network 90 in order to transmit the content data to the terminal device. After this disconnection handling process has been executed, the communication control apparatus 100 distributes the content data to the device 200b which is now functioning as a relay device, and the device 200b distributes the received content data to the device 200c which is functioning as a terminal device.

### Modifications

While the embodiments of the communication system 10 including the communication control apparatus 100 have been described above, each of the above-described embodiments is merely an example and, needless to say, various modifications can be made.

Detection of the communication state (e.g., the loss rate) described in the above-described embodiments is implemented as a result of the communication control apparatus 100 receiving data and calculating the loss rate; however, the calculation is not necessarily performed by the communication control apparatus 100. For example, a value of the communication state (e.g., the loss rate) of a content data distribution channel may be measured by the devices 200a to 200f at the reception side of content data distribution described in the second embodiment and may be transmitted by the devices 200a to 200f. The communication control apparatus 100 may obtain the value, thereby detecting the communication state. Also, it is assumed in the second embodiment that the content data includes video; however, the content data may further include audio or may include audio instead of video.

In the above-described embodiments, the no-reception-period threshold and the like are set only when the communication state of the network 90 has changed (step S34 in FIG. 7); however, this determination of step S34 may be omitted and the no-reception-period threshold and the like may be set every time the communication state is detected. However, it is advantageous to set the no-reception-period threshold and the like only when the communication state has changed because this can prevent an operation related to calculation of the no-reception-period threshold from being performed redundantly.

Also, in the above-described embodiments, the no-reception-period threshold y is set to a value obtained by multiplying the transmission intervals x by the ratio n (step S42 in FIG. 8). That is, in the case where the loss rate is higher than a predetermined value, the no-reception-period threshold y is set such that the value of the no-reception-period threshold y is larger than that of the case where the loss rate is equal to the predetermined value in terms of its relative magnitude based on the transmission intervals x. With this configuration, the no-reception-period threshold y can be appropriately set even if the transmission intervals x are changed in accordance with the communication state, for example. However, the no-reception-period threshold y need not be set on the basis of the transmission intervals x. For example, the no-reception-period threshold y may be set independently from the transmission intervals x such that, in the case where the loss rate is higher than a predetermined value, the no-reception-period threshold y is larger than that of the case where the loss rate is the predetermined value. Further, the no-reception-period threshold y may be set independently from the transmission intervals x such that, in the case where the loss rate is lower than the predetermined value, the no-reception-period threshold y is smaller than that of the case where the loss rate is the predetermined value.

Also, in the above-described embodiments, the communication control apparatus 100 is configured to periodically transmit a connection check message and the devices 200a to 200f are configured to transmit connection confirmation data in response to the connection check message for the purpose of alive monitoring. However, the communication control apparatus 100 may be configured not to transmit a connection check message and the devices 200a to 200f may be configured to spontaneously transmit connection confirmation data (so-called a heartbeat message) at certain transmission intervals. In this case, the communication control apparatus 100 may receive the connection confirmation data a predetermined number of times, identify the transmission intervals using the identifying unit 170, and use the identified transmission intervals as the transmission-interval base value x0 (step S42 in FIG. 8). Also, in the case where the transmission intervals are changed in step S37, the communication control apparatus 100 may instruct the device to change the transmission intervals of the connection confirmation data similarly. In response to this instruction, the device may change the transmission intervals of the connection confirmation data.

Also, in the disconnection detection process (see FIG. 5) described in the above-described embodiments, whether or not the connection confirmation data or other data is successfully received from the device is consecutively detected each time; however, this detection may be performed intermittently. That is, in the case where data is successfully received from the device within a first period indicated by the no-reception-period threshold y, elapse of the first period may be waited for. Thereafter, it may be checked whether or not data is successfully received within a second period indicated by the no-reception-period threshold y, the second period being subsequent to the first period. In this case, if data is not successfully received over a period indicated by the no-reception-period threshold, it is determined that the device has been disconnected from the network 90.

Also, in the above-described embodiments, the upper-limit false detection rate and the upper-limit no-reception-period threshold stored by the setting unit 110 are input by a user; however, predetermined values may be stored in a storage medium of the setting unit 110 at the manufacturing stage of the communication control apparatus 100. However, flexible system operation (such as changing system requirements) can be performed in accordance with the usage of the communication system when user input is permitted.

All or some of various processes (such as the processes illustrated in FIGS. 4, 5, 7, and 8) performed by the communication control apparatus 100 and the devices 200a to 200f described above may be executed by components (hardware) of the communication control apparatus 100 and the devices 200a to 200f, or may be executed by software. Execution of the processes by software is implemented as a result of a processor included in each of the communication control apparatus 100 and the devices 200a to 200f executing a control program stored in a memory. The control program may be distributed or put into market after being recorded on a storage medium. For example, the distributed control program may be installed into the communication control apparatus 100 and the devices 200a to 200f and may cause processors of the communication control apparatus 100 and the devices 200a to 200f to execute the control program. This consequently causes the communication control apparatus 100 and the devices 200a to 200f to execute various processes (such as the processes illustrated in FIGS. 4, 5, 7, and 8).

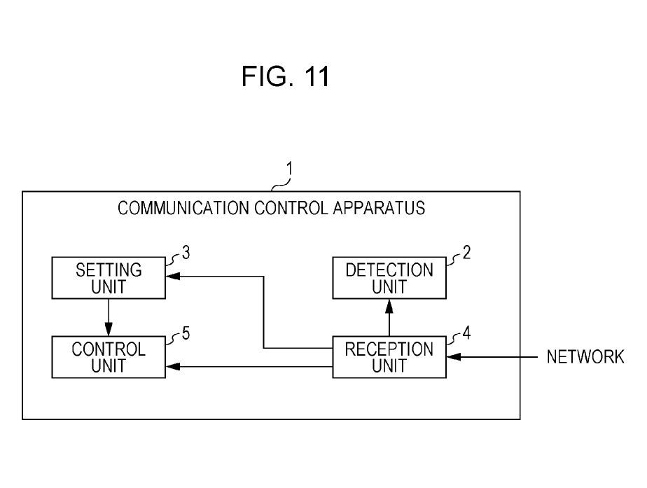

Also, a communication control apparatus 1 which is one embodiment of the present disclosure is a communication control apparatus that monitors a network connection state of a device on a network, and includes a detection unit 2 configured to detect a communication state of the network, a setting unit 3 configured to set a threshold for a period in accordance with the communication state detected by the detection unit 2, a reception unit 4 configured to receive data from the device via the network, and a control unit 5 configured to execute a predetermined process for taking an action against disconnection of the device from the network in the case where a period over which the reception unit 4 fails to receive data from the device has exceeded a threshold (see FIG. 11). Such a communication control apparatus 1 may be implemented as an integrated circuit.

Embodiments realized by making various modifications obviously conceivable by a person skilled in the art in the above-described embodiments or embodiments realized by combining the elements and functions described in the individual embodiments in a given manner are also within the scope of the present disclosure.

Embodiments of the present disclosure are usable to detect disconnection of a device from a network.

What is claimed is:

1. A communication control apparatus that monitors a network connection status of a device on a network, comprising:
a detection unit configured to detect a communication state of the network;
a setting unit configured to set a period in accordance with the communication state detected by the detection unit;
a reception unit configured to receive data from the device via the network; and
a controller configured to execute a predetermined process in a case where the reception unit fails to receive data from the device over the period.

2. The communication control apparatus according to claim 1, wherein
the detection unit detects, as the communication state of the network, a packet loss rate of the network,
in a case where the packet loss rate detected by the detection unit is higher than a predetermined value, the setting unit sets a longer period than a period that is set in a case where the packet loss rate is equal to the predetermined value, and
in a case where the packet loss rate detected by the detection unit is lower than the predetermined value, the setting unit sets a shorter period than the period that is set in a case where the packet loss rate is equal to the predetermined value.

3. The communication control apparatus according to claim 2, further comprising:
an identifying unit configured to identify transmission intervals of connection confirmation data that is periodically transmitted from the device, wherein
the period takes a value which is represented as a relative magnitude based on the transmission intervals,
in a case where the packet loss rate detected by the detection unit is higher than the predetermined value, the setting unit sets the period such that the value representing the period as a relative magnitude based on the transmission intervals is larger than the period that is set in a case where the packet loss rate is equal to the predetermined value, and
in a case where the packet loss rate detected by the detection unit is lower than the predetermined value, the setting unit sets the period such that the value representing the period as a relative magnitude based on the transmission intervals is smaller than the period that is set in a case where the packet loss rate is equal to the predetermined value.

4. The communication control apparatus according to claim 2, further comprising:
an identifying unit configured to identify transmission intervals of connection confirmation data that is periodically transmitted from the device; and
a transmission-interval changing unit configured to perform control so as to reduce the transmission intervals of the connection confirmation data, in a case where the setting unit is unable to set the period such that a relationship is satisfied in which Ân, where n represents a ratio of the period to the transmission intervals and A represents the packet loss rate, is smaller than or equal to a predetermined upper-limit false detection rate which is the upper limit of a false detection rate regarding disconnection and the period is shorter than or equal to a predetermined upper-limit period which is the upper limit of the period, wherein
the setting unit sets the period such that the relationship is satisfied in which Ân is smaller than or equal to the predetermined upper-limit false detection rate and the period is shorter than or equal to the predetermined upper-limit period if possible.

5. The communication control apparatus according to claim 4, further comprising:
an input unit configured to accept input of information that represents the predetermined upper-limit false detection rate, wherein
the setting unit sets the period using the predetermined upper-limit false detection rate input via the input unit.

6. The communication control apparatus according to claim 4, further comprising:
an input unit configured to accept input of information that represents the predetermined upper-limit period, wherein
the setting unit sets the period using the predetermined upper-limit period input via the input unit.

7. The communication control apparatus according to claim 2, wherein the detection unit detects the packet loss rate by calculating the packet loss rate on the basis of a frequency with which the reception unit has received data transmitted from the device.

8. The communication control apparatus according to claim 2, wherein
the detection unit repeatedly performs the detection, and
the setting unit determines a timing at which the period is updated, on the basis of a change in the communication state detected by the detection unit, and sets the period at the determined timing.

9. The communication control apparatus according to claim 2, further comprising:
a transmission unit configured to transmit content data which represents at least one of video and audio to the device via the network, wherein
the device has a function for transmitting the content data to an external terminal device upon receipt of the content data, and
the controller executes, as the predetermined process, control for changing a transmission path on the network in order to transmit the content data to the external terminal device.

10. The communication control apparatus according to claim 2, wherein the controller executes, as the predetermined process, a process for outputting information indicating that the device has been disconnected from the network.

11. The communication control apparatus according to claim 1, wherein
the detection unit detects the communication state of the network by calculating a degree at which smooth transmission of data is disturbed over the network, and
in a case where the calculated degree is larger than a predetermined reference, the setting unit sets a longer period than a period that is set in a case where the calculated degree is smaller than the predetermined reference.

12. The communication control apparatus according to claim 11, wherein the detection unit calculates, as the degree, a probability that data expected to reach the communication control apparatus from the device is not successfully received after a certain period has passed from expected arrival time.

13. An integrated circuit for monitoring a network connection status of a device on a network, comprising:
a reception unit configured to receive data from the device via the network;
a detection unit configured to detect a communication state of the network;
a setting unit configured to set a period in accordance with the communication state detected by the detection unit; and
a controller configured to execute a predetermined process in a case where the reception unit fails to receive data from the device over the period.

14. A communication control method employed by a communication control apparatus that monitors a network connection status of a device on a network, comprising:
a detecting step of detecting a communication state of the network;
a setting step of setting a period in accordance with the communication state detected in the detecting step;
a receiving step of receiving data from the device via the network; and
a control step of executing a predetermined process in a case where data is not successfully received from the device over the period in the receiving step.

15. A non-transitory computer-readable recording medium having a program causing an apparatus including a processor to execute a communication control process for monitoring a network connection status of a device on a network, the communication control process comprising:
a detecting step of detecting a communication state of the network;
a setting step of setting a period in accordance with the communication state detected in the detecting step;
a receiving step of receiving data from the device via the network; and
a control step of executing a predetermined process in a case where data is not successfully received from the device over the period in the receiving step.
